(19) United States
(12) Patent Application Publication
(10) Pub. No.: US 2016/0209715 A1
(43) Pub. Date: Jul. 21, 2016

(54) LIQUID CRYSTAL DISPLAY DEVICE

(71) Applicant: Samsung Display Co., Ltd., Yongin-City (KR)

(72) Inventors: Soon Joon RHO, Suwon-si (KR); Keun Chan OH, Cheonan-si (KR); Hye Lim JANG, Hwaseong-si (KR)

(21) Appl. No.: 14/958,027

(22) Filed: Dec. 3, 2015

(30) Foreign Application Priority Data
Jan. 16, 2015 (KR) 10-2015-0008147

(51) Int. Cl. G02F 1/1343; G02F 1/1362; G02F 1/1333; G02F 1/1368

(52) U.S. Cl. CPC G02F 1/134309; G02F 1/1368; G02F 1/136286; G02F 1/133345; G02F 2001/134345

(57) ABSTRACT

A liquid crystal display device includes a first substrate, a gate line and a first data line disposed on the first substrate and insulated from each other, a first thin film transistor connected to the gate line and the first data line, a lower pixel electrode connected to the first thin film transistor, an interlayer insulating layer disposed on the lower pixel electrode, an upper pixel electrode disposed on the interlayer insulating layer and connected to the first thin film transistor and the lower pixel electrode, a second substrate facing the first substrate, a common electrode disposed on the second substrate, and a liquid crystal layer disposed between the first substrate and the second substrate. The upper pixel electrode includes a plurality of minute branches. A ratio of an interval between the minute branches with respect to a thickness of the liquid crystal layer is 2.7 to 5.0.

### CLAIM OF PRIORITY

This application makes reference to, incorporates the same herein, and claims all benefits accruing under 35 U.S.C. §119 from an application earlier filed in the Korean Intellectual Property Office on 16 Jan. 2015 and there duly assigned Serial No. 10-2015-0008147.

### BACKGROUND OF THE INVENTION

1. Field of the Invention

The present invention relates to a liquid crystal display device.

2. Description of the Related Art

A liquid crystal display device is one of the flat panel displays which are most widely used in recent years and includes two display panels in which a field generating electrode such as a pixel electrode and a common electrode is formed and a liquid crystal layer interposed between the display panels.

A voltage is applied to the field generating electrode to generate an electric field in the liquid crystal layer, and an orientation of liquid crystal molecules of the liquid crystal layer is determined therethrough, and polarization of incident light is controlled to display an image.

Among the liquid crystal displays, a vertically aligned (VA) mode liquid crystal display in which a major axis of the liquid crystal molecule is arranged to be vertical to upper and lower display panels in a state where no electric field is applied is getting the spotlight because it has a high contrast ratio and easily achieves a wide reference viewing angle.

In order to achieve a wide viewing angle in such a vertically aligned (VA) mode liquid crystal display, a plurality of domains having different liquid crystal alignment directions may be formed in one pixel.

As described above, in order to firm the plurality of domains, a method of forming a cutout such as a minute slit in the field generating electrode or a method of forming, a protrusion on the field generating electrode is used. According to this method, the liquid crystals are aligned to be vertical to the fringe field which is formed between an edge of the cutout or the protrusion and the field generating electrode, which faces the edge, thereby forming a plurality of domains.

In the meantime, when the plurality of slits is formed in the field generating electrode, transmittance in a portion where the slit is formed is undesirably lowered.

The above information disclosed in this Background section is only for enhancement of understanding of the background of the invention and therefore it may contain information that does not farm the prior art that is already known in this country to a person of ordinary skill in the art.

### SUMMARY OF THE INVENTION

The present invention has been made in an effort to improve the quality of as liquid crystal display device.

An object of the present invention is to improve transmittance of a liquid crystal display device in which a plurality of minute slits is formed in a field generating electrode.

A liquid crystal display device according to an exemplary embodiment of the present invention includes a first substrate, a gate line, and a first data line which are disposed on the first substrate and are insulated from each other, a first thin film transistor which is connected to the gate line and the first data line, a lower pixel electrode which is connected to the first thin film transistor, an interlayer insulating layer which is disposed on the lower pixel electrode, an upper pixel electrode which is disposed on the interlayer insulating layer and is connected to the first thin film transistor and the lower pixel electrode, a second substrate which faces the first substrate, a common electrode which is disposed on the second substrate, and a liquid crystal layer which is disposed between the first substrate and the second substrate, and the lower pixel electrode and the upper pixel electrode overlap each other, the upper pixel electrode includes a plurality of minute branches, the lower pixel electrode has a whole plate shape in plan view, and a ratio of an interval between the minute branches with respect to a thickness of the liquid crystal layer is 2.7 to 5.0.

The liquid crystal layer may include liquid crystal molecules having a negative dielectric anisotropy.

The lower pixel electrode may include a first lower subpixel electrode and a second lower subpixel electrode which are separated from each other, and the upper pixel electrode may include a first upper subpixel electrode and a second upper subpixel electrode which are separated from each other.

The first lower subpixel electrode and the first upper subpixel electrode may overlap each other and the second lower subpixel electrode and the second upper subpixel electrode may overlap each other.

Each of the first upper subpixel electrode and the second upper subpixel electrode may include as cross-shaped stein portion which is formed of a horizontal stem portion and a vertical stem portion that intersects the horizontal stem portion and the minute branch may extend from the cross-shaped stem portion.

The liquid, crystal display according to the exemplary embodiment of the present invention may further include as second thin film transistor which is connected to the gate line and the first data line and as third thin film transistor which is connected to an output terminal of the second thin film transistor.

The first lower subpixel electrode and the first upper subpixel electrode may be connected to the first thin film transistor and the second lower subpixel electrode and the second upper subpixel electrode may be connected to the second thin film transistor.

The liquid crystal display according to the exemplary embodiment of the present invention may further include a reference voltage, line which is connected to an output terminal of the third thin film transistor.

The liquid crystal display according to the exemplary embodiment of the present invention may further include a second data line which intersects the gate line and a second thin film transistor which is connected to the gate line and the second data line.

The first lower subpixel electrode, and the first upper subpixel electrode may be connected to the first thin film transistor and the second lower subpixel electrode and the second upper subpixel electrode may be connected to the second thin film transistor.

According to the present invention, transmittance may be improved by adjusting a thickness of the liquid crystal layer, a dielectric anisotropy of the liquid crystal, and a pitch of the minute branch portions.

Further, the transmittance may be improved by adjusting the width of the minute branches and the minute slits which form the minute branch portion.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an equivalent circuit diagram of one pixel of a liquid, crystal display according to an exemplary embodiment of the present invention.

FIG. 2 is a layout view of one pixel of a liquid crystal display according to an exemplary embodiment of the present invention.

FIG. 3 is a cross-sectional view of the liquid crystal display taken along the line III-III of FIG. 2.

FIG. 4 is an enlarged view of a portion A of FIG. 2.

FIG. 5 is an equivalent circuit diagram of one pixel of a liquid crystal display according to another exemplary embodiment of the present invention.

FIG. 6 is a layout view of one pixel of a liquid crystal display according to another exemplary embodiment of the present invention.

FIG. 7 is a cross-sectional view of the liquid crystal display taken along the line VII-VII of FIG. 6.

FIG. 8 is a top plan view illustrating a pixel electrode of the liquid crystal display of FIG. 6.

### DETAILED DESCRIPTION OF THE EMBODIMENTS

Hereinafter, the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

The size and thickness of the components shown the drawings are optionally determined for better understanding and ease of description, and the present invention is not limited to the examples shown in the drawings.

In the drawings, the thickness of layers, films, panels, regions, etc., are exaggerated for clarity. In addition, in the drawings, for understanding and ease of description, the thicknesses of some layers and areas are exaggerated. It will be understood that when an element such as a layer, film, region, or substrate is referred to as being “on” another element, it can be directly on the other element or intervening elements may also be present.

Further, unless explicitly described to the contrary, the word “comprise” and variations such as “comprises” or “comprising”, will be understood to imply the inclusion of stated elements but not the exclusion of any other elements. In addition, throughout the specification, “on” implies being positioned above or below a target element and does not imply being necessarily positioned on the top on the basis of a gravity direction.

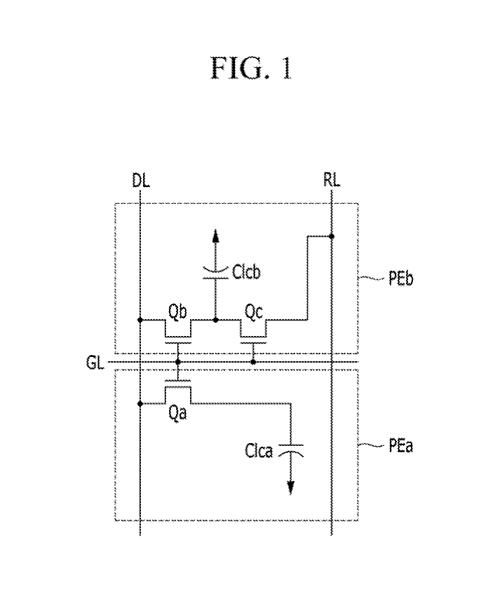

First, a liquid crystal display device according to an exemplary embodiment of the present invention will be described with reference to FIGS. 1 to 4.

FIG. 1 is an equivalent circuit diagram of one pixel of a liquid crystal display device according to an exemplary embodiment of the present invention.

Referring to FIG. 1, one pixel PX of a liquid crystal display device according to the present exemplary embodiment includes a plurality of signal lines including a gate line GL which transmits a gate signal, a data line DL which transmits a data signal, and a reference voltage line RL which transmits a divided reference voltage, first, second, and third switching elements Qa, Qb, and Qc which are connected to the plurality of signal lines and first and second liquid crystal capacitors Clca and Clcb.

The first and second switching elements Qa and Qb are connected to the gate line GL and the data line DL, and the third switching element Qc is connected to an output terminal of the second switching element Qb and the reference voltage line RL.

The first switching element Qa and the second switching element Qb are three terminal elements such as a thin film transistor. A control terminal thereof is connected to the gate line GL, an input terminal thereof is connected to the data line DL, an output terminal of the first switching element Qa is connected to the first liquid crystal capacitor Clca, and an output terminal of the second switching element Qb is connected to the second liquid crystal capacitor Clcb and an input terminal of the third switching element Qc.

The third switching element Qc is also a three terminal element such as a thin film transistor in which a control terminal is connected to the gate line GL, an input terminal is connected to the second liquid crystal capacitor Clcb, and an output terminal is connected to the reference voltage line RL.

When a gate on signal is applied to the gate line GL, the first switching element Qa, the second switching element Qb, and the third switching element Qc which are connected to the gate line GL are turned on. Therefore, a data voltage which is applied to the data line DL is applied to a first subpixel electrode PEa and a second subpixel electrode PEb through the turned-on first switching element Qa and second switching, element Qb, respectively. In this case, the data voltages which are applied to the first subpixel electrode PEa and the second subpixel electrode PEb are equal to each other, and the first liquid crystal capacitor Clca and the second liquid crystal capacitor Clcb are charged with a value which is equal to a difference between a common voltage and the data voltage. Simultaneously to this, the voltage which is charged into the second liquid crystal capacitor Clcb is divided by the turned on third switching element Qc. By doing this, the voltage which is charged into the second liquid crystal capacitor Clcb is lowered by a difference between the common voltage and the divided reference voltage. That is, the voltage which is charged into the first liquid crystal capacitor Clca is higher than the voltage which is charged into the second liquid crystal capacitor Clcb.

As described above, the voltage which is charged into the first liquid crystal capacitor Clca is different from the voltage which is charged into the second liquid crystal capacitor Clcb. Since the voltage which is charged into the first liquid crystal capacitor Clca is different from the voltage which is charged into the second liquid crystal capacitor Clcb, inclined angles of the liquid crystal molecules in the first subpixel and the second subpixel are different from each other, so that the luminances of two subpixels are different from each other. Therefore, when the voltage of the first liquid crystal capacitor Clca and the voltage of the second liquid crystal capacitor Clcb are appropriately adjusted, an image which is seen from the side is closer to an image which is seen from the front as much as possible, thereby improving a side visibility.

In the illustrated exemplary embodiment, in order to make the voltage which is charged into the first liquid crystal capacitor Clca be different from the voltage which is charged into the second liquid crystal capacitor Clcb, a third switching element Qc which is connected to the second liquid crystal capacitor Clcb and the reference voltage line RL is provided. However, in the liquid crystal display according to another exemplary embodiment of the present invention, the second liquid crystal capacitor Clcb may be connected to a step-down capacitor. Specifically, a third switching element including as first terminal which is connected to a step down gate line, a second terminal which is connected to a second liquid crystal capacitor Clcb, and a third terminal which is connected to the step down capacitor is provided so that a part of as quantity of charges charged into the second liquid crystal capacitor Clcb is charged into the step-down capacitor, thereby setting charged voltages between the first liquid crystal capacitor Clca and the second liquid crystal capacitor Clcb to be different from each other.

In addition, the charged voltage between the first liquid crystal capacitor Clca and the second liquid crystal capacitor Clcb may be set to be different from each other using various methods.

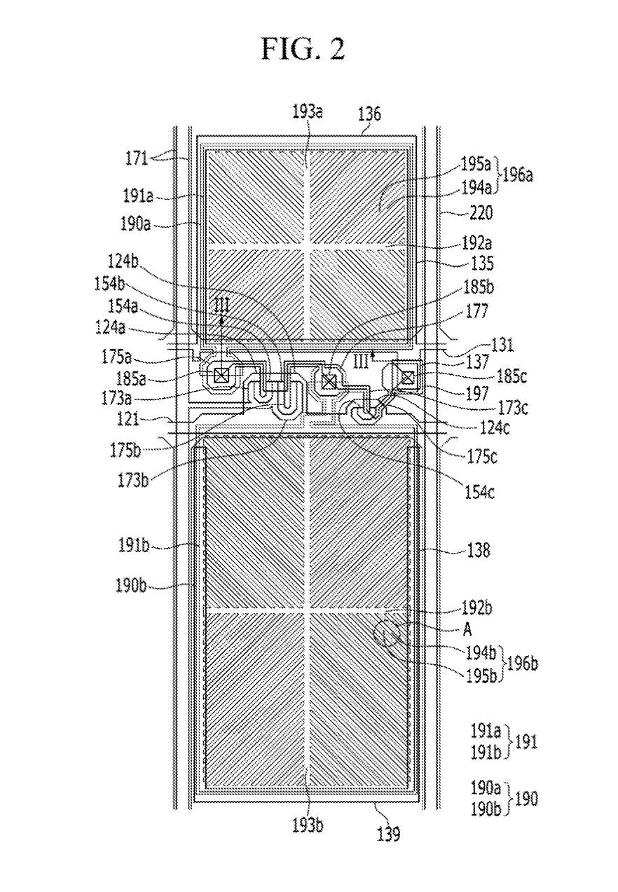

Now, a structure of the liquid crystal display according to the exemplary embodiment illustrated in FIG. 1 will be described in brief with reference to FIGS. 2 to 4.

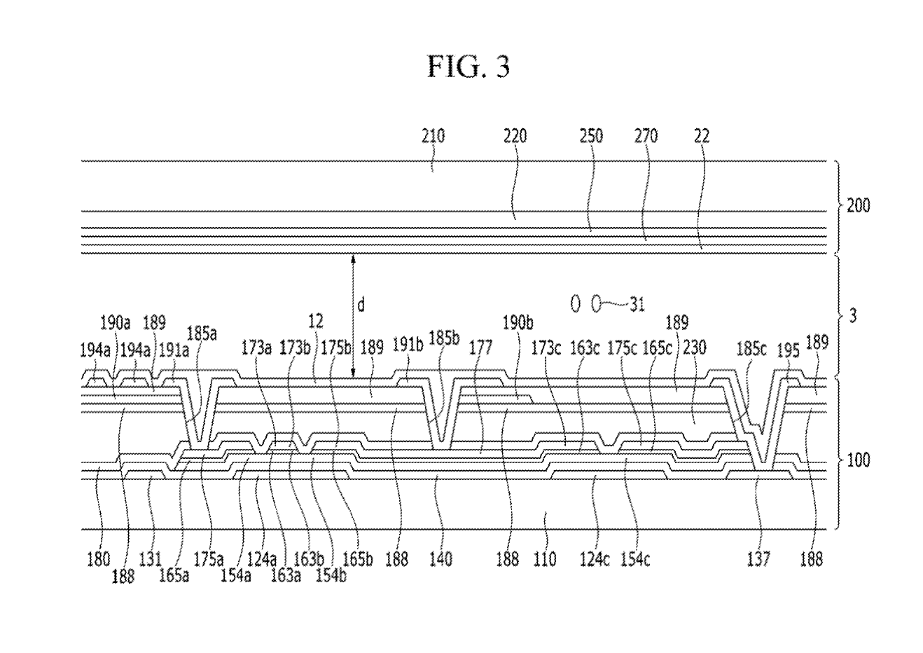

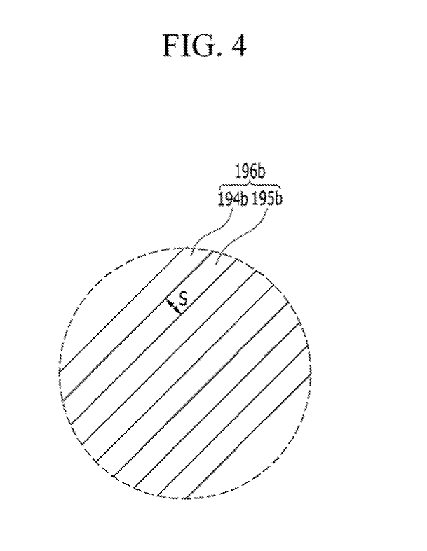

FIG. 2 is a layout, view of one pixel of a liquid crystal display according to an exemplary embodiment of the present invention. FIG. 3 is a cross-sectional view of the liquid crystal display taken along the line III-III of FIG. 2. FIG. 4 is an enlarged view of a portion A of FIG. 2.

Referring to FIG. 2 to FIG. 4, a liquid crystal display according to the present exemplary embodiment includes a first display panel for substrate) 100, a second display panel (or substrate) 200 which faces the first display panel 100, and a liquid crystal layer 3 interposed between the first and second display panels 100 and 200.

Hereinafter, the first display and 100 will be described.

A gate line 121 and a reference voltage line 131 are disposed on a first insulation substrate 110 which is formed of a transparent glass or plastic.

The gate line 121 mainly extends in a horizontal direction, transmits a gate signal, and includes a first gate electrode 124a a second gate electrode 124b and a third gate electrode 124c. The gate line 121 further includes a wide end portion not illustrated) to be connected with other layer or an external driving circuit.

The reference voltage line 131 mainly extends in to horizontal direction, transmits a predetermined voltage such as a reference voltage, and includes a first vertical storage electrode 135, a first horizontal storage electrode 136, and a reference electrode 137. The first vertical and horizontal storage electrodes 135 and 136 enclose a first upper subpixel electrode 191a which will be described below and the reference electrode 137 protrudes toward the gate line 121. Further, the reference voltage line 131 includes a second vertical storage electrode 138, a second horizontal storage electrode 139 which enclose a second upper subpixel electrode 191b which will be described below. Even though not illustrated in FIG. 1, the first horizontal storage electrode 136 may be connected with the second horizontal storage electrode 139 of a previous pixel by an integrated wiring line.

A gate insulating layer 140 is disposed on the gate line 121 and the reference voltage line 131 and a first semiconductor 154a, a second semiconductor 154b, and a third semiconductor 154c which are formed of an amorphous or polysilicon are disposed on the gate insulating layer 140. Further, the first semiconductor 154a, the second semiconductor 154b, and the third semiconductor 154c may be formed of oxide semiconductors.

A plurality of pairs of ohmic contacts 163a, 165a, 163b, 165b, 163c, and 165c are disposed on the first semiconductor 154a, the second semiconductor 154b, and the third semiconductor 154c, respectively. The ohmic contacts 163a, 165a, 163b, 165b, 163c, and 165c may be formed of suicide or n+ hydrogenated amorphous silicon doped with an n-type impurity at a high concentration. Further, when the first semiconductor 154a, the second semiconductor 154b, and the third semiconductor 154c are formed of the oxide semiconductors, the ohmic contacts 163a, 165a, 163b, 165b, 163c, and 165c may be omitted.

Data conductors 171, 173a, 173b, 173c, 175a, 175b. and 175c including a plurality of data lines 171 including a first source electrode 173a and as second source electrode 173b, a first drain electrode 175a, a second drain electrode 175b, a third source electrode 173c, and a third drain electrode 175c are disposed on the ohmic contacts 163a, 165a, 163b, 165b, 163c, and 165c and the gate insulating layer 140.

The data lines 171 transmit data signals and mainly extend in a vertical direction to intersect the gate line 121 and the reference voltage line 131. The first source electrode 173a and the second drain electrode 175b overlap the first semiconductor 154a, the second source electrode 173b and the second drain electrode 175b overlap the second semiconductor 154b, and the third source electrode 173c and the third drain electrode 175c overlap the third semiconductor 154c. The first source electrode 173a and the first drain electrode 175a are opposite to each other with the first gate electrode 124a therebetween, the second source electrode 173b and the second drain electrode 175b are opposite to each other with the second gate electrode 124b therebetween, and the third source electrode 173c and the third drain electrode 175c are opposite to each other with the third gate electrode 124c therebetween. The second drain electrode 175b is connected with the third source electrode 173c and includes an expansion 177 which widely expands. However, the exemplary embodiment is not limited thereto, but shapes and arrangements of the, data lines 171 including the first, second and third drain electrodes 175a, 175b, and 175c may vary in various ways.

Further, the data line 171 may include a wide end portion not illustrated) to be connected with other layer or an external driving circuit.

The first gate electrode 124a, the first source electrode 173a, the first drain electrode 175a and the first semiconductor 154a form a first thin film transistor (TFT) Qa, and a channel of the first thin film transistor Qa is formed in the first semiconductor 154a between the first source electrode 173a and the first drain electrode 175a. Similarly, the second gate electrode 124b, the second source electrode 173b, the second drain electrode 175b and the second semiconductor 154b form a second thin film transistor Qb, and a channel of the second thin film transistor Qb is formed in the second semiconductor 154b between the second source electrode 173b and the second drain electrode 175b. Further, the third gate electrode 124c, the third source electrode 173c, the third drain electrode 175c and the third semiconductor 154c form a third thin film transistor Qc, and a channel of the third thin film transistor Qc is formed in the third semiconductor 154c between the third source electrode 173c and the third drain electrode 175c.

A passivation layer 180 is disposed on the data conductors 171, 173a, 173b, 173c, 175a, 175b, and 175c, and on exposed portions of the first, second, and third semiconductors 154a, 154b, and 154c. The passivation layer 180 may be formed of an inorganic insulating material such as silicon nitride or silicon oxide. The passivation layer 180 may prevent a pigment of a color filter 230, which will be described below, from inflowing into exposed portions of the first, second, and third semiconductors 154a, 154b, and 154c.

The color filter 230 is disposed on the passivation layer 180. The color filter 230 extends in a vertical direction along two adjacent data lines 171.

The color filter 230 may represent one of three primary colors of red, green, and blue. However, the color which is represented by the color filter is not limited to three primary colors of red, green, and blue, but may be one of cyan, magenta, yellow, and white.

An overcoat 188 is disposed on the color filter 230.

The overcoat 188 may be formed of an inorganic insulating material such as silicon nitride or silicon oxide. The overcoat 188 prevents the color filter 230 from being loosen, and suppresses the contamination of the liquid crystal layer 3 by an organic material such as a solvent which inflows from the color filter 230, thereby preventing faulty such as an image lag caused when a screen is driven.

A lower pixel electrode 190 is disposed on the overcoat 188.

The lower pixel electrode 190 includes a first lower subpixel electrode 190a and a second lower subpixel electrode 190b which are separated from each other with the gate line 121 therebetween and adjacent to each other in a column direction with respect to the gate line 121. The first lower subpixel electrode 190a and the second lower subpixel electrode 190b are located in a first subpixel area and a second subpixel area, respectively. The first subpixel area and the second subpixel area form one pixel area.

The first lower subpixel electrode 190a and the second lower subpixel electrode 190b have a planar shape having a whole plate shape over the first subpixel area and the second subpixel area. Here, the whole plate means a plate shape which is not split as one body.

The lower pixel electrode 190 may be formed of a transparent material such as indium tin oxide (ITO) and indium zinc oxide (IZO). Further, the lower pixel electrode 190 may be also formed of a reflective metal such as aluminum, silver, chromium or an alloy thereof.

An interlayer insulating layer 189 is disposed on the overcoat 188 and the lower pixel electrode 190. The interlayer insulating layer 189 may be formed of an inorganic insulating material such as silicon nitride or silicon oxide. Further, the interlayer insulating layer 189 may be formed of an organic insulating material.

A first contact hole 185a and a second contact hole 185b are located in the passivation layer 180, the color filter 230, the overcoat 188, and the interlayer insulating layer 189 to expose the first drain electrode 175a and the second drain electrode 175b, respectively. Further, the third contact hole 185c is located in the passivation layer 180, color filter 230, the overcoat 188, the interlayer insulating layer 189, and the gate insulating layer 140 to expose a part of the reference electrode 137 and a part of the third drain electrode 175c.

Upper pixel electrodes 191 which are separated from each other and a connecting member 197 are disposed on the interlayer insulating layer 189.

The upper pixel electrode 191 includes a first upper subpixel electrode 191a and a second upper subpixel electrode 191b which are separated from each other with the gate line 121 therebetween and adjacent to each other with respect to the gate line 121. The first upper subpixel electrode 191a overlaps the first lower subpixel electrode 190a, and the second upper subpixel electrode 191b overlaps the second lower subpixel electrode 190b.

The upper pixel, electrode 191 and the connecting, member 197 may be formed of a transparent material such as ITO and IZO. The upper pixel electrode 191 and the connecting member 197 may be also funned of a reflective metal such as aluminum, silver, chromium or an alloy thereof.

The first upper subpixel electrode 191a and the second upper subpixel electrode 191b include cross-shaped stem portions which have a quadrangular shape as an overall shape and are formed of horizontal stem portions 192a and 192b, respectively, and vertical stem portions 193a and 193b, respectively, intersecting the horizontal stem portions.

Further, the first upper subpixel electrode 191a and the second upper subpixel electrode 191b are divided into four sub regions by the horizontal stem portions 192a and 192b, respectively, and the vertical stem portions 193a and 193b, respectively, and each sub region includes a plurality of minute branch portions 196a and 196b, respectively. Each minute branch portion 196a and 196b includes minute branches 194a and 194b, respectively, and minute slits 195a and 195b, respectively.

One of the minute branch portions 196a (or 196b) of the first upper subpixel electrode 191a (or of the second upper subpixel electrode 191b) obliquely extends from the horizontal stem portion 192a (or from the horizontal portion 192b) or from the vertical stem portion 193a for from the vertical stem portion 193b) in a left upper direction. The other minute branch portions 196a, for example, obliquely extends from the horizontal stem portions 192a or from the vertical stem portions 193a in a right upper direction. Further, another one of the minute branch portions 196a, for example, obliquely extends from the horizontal stem portions 192a or from the vertical stem portions 193a in a left lower direction, and still the other one of the minute branch portions 196a, for example, obliquely extends from the horizontal stem portions 192a or from the vertical stem portions 193a in a right lower direction. As shown in FIG. 2, the same arrangements of the minute branch portions 196a can be applied to the minute branch portions 196b.

The minute branch portion 196a extends in a direction formed approximately 40 degrees to 45 degrees with respect to the gate line 121 or the horizontal stem portions 192a. The minute branch portion 196b extends in as direction formed approximately 40 degrees to 45 degrees with respect to the gate line 121 or the horizontal stem portion 192b. Particularly, the extension direction of the minute branch portion 196a included in the first upper subpixel electrode 191a may form approximately 40 degrees with respect to the horizontal stem portion 192a, and the extension direction of the minute branch portion 196b included in the second upper subpixel electrode 191b may form approximately 45 degrees with respect to the horizontal stem portion 192b. Further, minute branch portions 196a and 196b of two adjacent sub regions may be perpendicular to each other.

The first upper subpixel electrode 191a and the first lower subpixel electrode 190a are physically and electrically connected to each other through the first contact hole 185a. Further, the first upper subpixel electrode 191a is physically and electrically connected to the first drain electrode 175a through the first contact hole 185a. Accordingly, a data voltage is applied to the first upper subpixel electrode 191a and the first lower subpixel electrode 190a from the first drain electrode 175a.

The second upper subpixel electrode 191b and the second lower subpixel electrode 190b are physically and electrically connected to each other through the second contact hole 185b. Further, the second upper subpixel electrode 191b is physically and electrically connected to the second drain electrode 175b through the second contact hole 185b. Accordingly, the data voltage is applied to the second upper subpixel electrode 191b and the second lower subpixel electrode 190b from the second drain electrode 175b.

The connecting member 197 is electrically connected to the reference electrode 137 and the third drain electrode 175c which are exposed through the third contact hole 185c.

Some data voltage which is applied to the second drain electrode 175b is divided by the third source electrode 173c so that the voltage which are applied to the first upper subpixel electrode 191a and the first lower subpixel electrode 190a are higher than the voltages which are applied to the second upper subpixel electrode 191h and the second lower subpixel electrode 190b. In this case, voltages which are applied to the first upper subpixel electrode 191a and the first lower subpixel electrode 190a and the second upper subpixel electrode 191b and the second lower subpixel electrode 190b are positive (+). In contrast, when voltages which are applied to the first upper subpixel electrode 191a and the first lower subpixel electrode 190a and the second upper subpixel electrode 191b and the second lower subpixel electrode 190b are negative (−), voltages which are applied to the first upper subpixel electrode 191a and the first lower subpixel electrode 190a are lower than voltages which are applied to the second upper subpixel electrode 191b and the second lower subpixel electrode 190b.

A lower alignment layer 12 is located on the interlayer insulating layer 189, the upper pixel electrode 191, and the connecting member 197.

Hereinafter, the second display panel 200 will be described.

A light blocking member 220 is formed on a second insulation substrate 210 which is formed of a transparent glass or plastic.

The light blocking, member 220 extends along the data line 171 and the gate line 121. A width of the light blocking member 220 may be larger than a width of the data line 171 and a width of the gate line 121. As described above, the width of the light blocking member 220 is larger than the width of the data line 171 and the width of the gate line 121 so that the light blocking member 220 may prevent the light which is incident from the outside from being reflected from a surface of the data line 171 which is formed of a metal. Accordingly, the light which is reflected from the surfaces of the data line 171 and the gate line 121 interferes with light which passes through the liquid crystal layer 3, which may prevent the contrast ratio of the liquid crystal display from being lowered.

A plantarization layer 250 is disposed on the light blocking member 220, a common electrode 270 is disposed on the plantarization layer 250, and an upper alignment layer 22 is disposed on the common electrode 270.

The lower alignment layer 12 and the upper alignment layer 22 may be formed of vertical alignment layers and may be formed of an alignment material such as polyamic acid, polysiloxane, or polyimide.

The liquid crystal layer 3 includes a plurality of liquid crystal molecule 31 having a negative dielectric anisotropy and the liquid crystal molecule 31 may be aligned such that a major axis is vertical, to the surfaces of the first and second display panels 100 and 200 in a state where no electric field is applied.

Further, the liquid crystal layer 3 may include a prepolymer such as a monomer which is cured by polymerization by light. The prepolymer may include a reactive mesogen which is polymerized by light such as ultraviolet rays.

In the meantime, the lower alignment layer 12 and the upper alignment layer 22 may include prepolymer such as a monomer which is cured by polymerization by light. In this case, the liquid crystal layer 3 does not include the prepolymer.

The first upper subpixel electrode 191a and the first lower subpixel electrode 190a and the second upper subpixel electrode 191b and the second lower subpixel electrode 190b to which the data voltages are applied generate an electric field together with the common electrode 270 of the second display panel 200, to determine a direction of the liquid, crystal molecules 31 of the liquid crystal layer 3 between the first display panel 100 and the second display panel 200. Luminance of the light which passes through the liquid crystal layer 3 varies depending on the direction of the liquid crystal molecules 31 determined as described above.

In the present exemplary embodiment, the plate shaped first lower subpixel electrode 190a and second lower subpixel electrode 190b are disposed to overlap the first upper subpixel electrode 191a and the second upper subpixel electrode 191b, respectively, each including minute branches 194a and 194b, thereby increasing transmittance of the liquid crystal display.

More specifically, in regions corresponding to the minute slits 195a and 195b between the minute branches 194a and 194b of the first upper subpixel electrode 191a and the second upper subpixel electrode 191b, an electric field is generated between the whole plate shaped first lower subpixel electrode 190a and second lower subpixel electrode 190b and the common electrode 270 so that the electric field is prevented from being lowered even in a region where a cutout for forming a plurality of branch electrodes is formed, thereby increasing the transmittance of the liquid crystal display.

In the meantime, in the present exemplary embodiment, an interval S (FIG. 4) between two adjacent minute branches 194a of the first upper subpixel electrode 191a is 2.7 to 5.0 times larger than a thickness d of the liquid crystal layer 3, which is a cell gap d shown in FIG. 3. An interval between two adjacent minute branches 194b of the second upper subpixel electrode 191b may be the same as the interval S between two adjacent minute branches 194a, and is 2.7 to 5.0 times larger than a thickness d of the liquid crystal layer 3. The thickness of the liquid crystal layer 3 is the cell gap d, which is a site of the liquid crystal layer 3 along the direction between the first and second display panels 100 and 200. The interval S between two adjacent minute branches 194b also can be referred to as a width S of the slit 195b, as shown in FIG. 4. However, the interval between two adjacent minute branches 194a can be different from the interval between two adjacent minute branches 194b, as long as these intervals are in the range between 2.7 to 5.0 times larger than a thickness d of the liquid crystal layer 3. In the case that the cell thickness d is not uniform over the panel, the cell thickness d can be defined as an average values over the panel.

Now, a relationship of the width S of the minute slits 195a and 195b and the cell gap d will be described with reference to Table 1.

In Table 1, as compared with a structure of a pixel electrode including the first subpixel electrode, and the second subpixel electrode having a minute branch portion including a plurality of minute slits and a plurality of minute branches, when a liquid crystal display device according to the exemplary embodiment of the present invention, the lower pixel electrode including the whole plate shaped first lower subpixel electrode and second lower subpixel electrode interposes the upper pixel electrode including the first upper subpixel electrode and the second upper subpixel electrode having the minute branch portion with the insulating layer therebetween, and the same voltage is applied to the lower pixel electrode and the upper pixel electrode, a ratio of the transmittance and a response time in a black state is measured, while changing a ratio of the width S of the minute slits 195a and 195b with respect to the cell gap d.

TABLE 1

| S/d | Transmittance (%) | Ton (%) |
|---|---|---|
| 1.3 | 87.6 | 10.1 |
| 1.7 | 51 | 3.3 |
| 2.0 | 53.4 | 82.9 |
| 2.7 | 104.4 | 1.8 |
| 3.3 | 104.9 | 1.9 |
| 4.0 | 104.8 | 2 |
| 5.0 | 105.2 | 2.2 |
| 5.3 | 94.1 | 1.9 |

Referring to Table 1, when a ratio of the width S of the minute slits 195a and 195b with respect to the cell gap d is 2.7 to 5.0, a ratio of the transmittance is 100% or higher than that of the structure of the pixel electrode which includes only minute branch portions. That is, it is understood that according to the liquid crystal display of the exemplary embodiment of the present invention, the transmittance of the liquid crystal display is increased.

It is also understood that when the ratio of the width S of the minute slits 195a and 195b with respect to the cell gap d is 2.7 to 5.0, a ratio of the response time in the black state is reduced by approximately 98% as compared with the structure of the pixel electrode which includes only minute branch portions. That is, it is understood that the response time in the black state of the liquid crystal display according to the exemplary embodiment of the present invention is much shorter. Therefore, it is understood that the luminance in the black state of the liquid crystal display according to the exemplary embodiment of the present invention is improved.

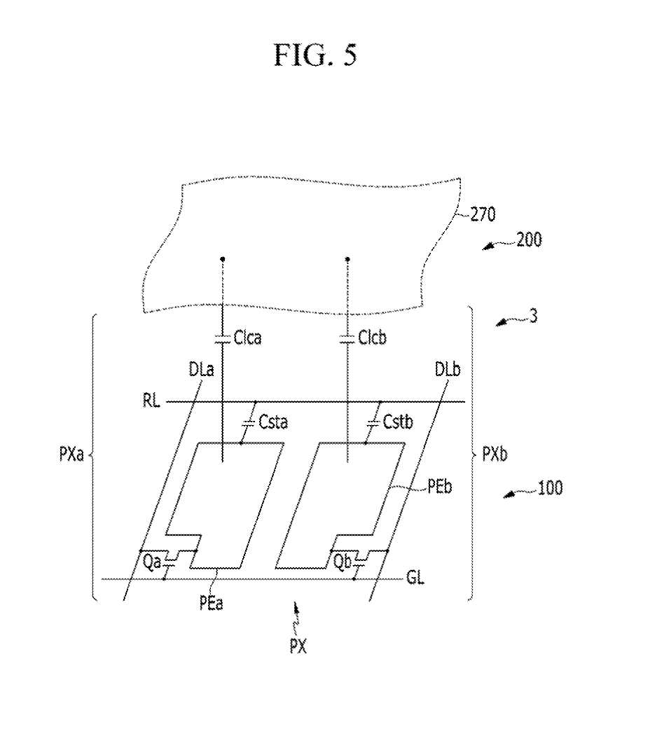

Now, as liquid crystal display device, according, to another exemplary embodiment of the present invention will be described with reference to FIGS. 5 to 8.

FIG. 5 is an equivalent circuit diagram of one pixel of a liquid crystal display according to another exemplary embodiment of the present invention.

Referring to FIG. 5, a liquid crystal display according to the present exemplary embodiment includes a first display panel (or substrate) 100, a second display panel (or substrate) 200 which face the first display panel 100, and a liquid crystal layer 3 interposed between the first and second display panels 100 and 200.

The liquid crystal display device according to the present exemplary embodiment includes signal lines including a plurality of gate lines GL, a plurality of pairs of data lines DLa and DLb, and a plurality of reference voltage lines RL and a plurality of pixels PX connected to the signal lines.

Each pixel PX includes subpixels PXa and PXb. The subpixel PXa includes switching element Qa, liquid crystal capacitor Clca, and storage capacitor Csta. The subpixel PXb includes switching element Qb, liquid crystal capacitor Clcb, and storage capacitor Cstb

The switching elements Qa and Qb are three terminal elements such as a thin film transistor which is provided in a first display panel 100. A control terminal thereof is connected to the gate line GL, an input terminal is connected to the data lines DLa and DLb, respectively, and an output terminal thereof is connected to the liquid crystal capacitors Clca and Clcb, respectively, and the storage capacitors Csta and Cstb, respectively.

The liquid crystal capacitors Clca and Clcb have subpixel electrodes PEa and PEb, respectively, and the common electrode 270 as two terminals and a portion of the liquid crystal layer 3 between the two terminals is formed of a dielectric material.

The storage capacitors Csta and Cstb which serve as auxiliary capacitors of the liquid crystal capacitors Clca and Clcb, respectively, are formed such that the reference voltage line RL and the subpixel electrodes PEa and PEb provided in the first display panel 100 overlap with an insulator therebetween and a predetermined voltage such as a common voltage Vcom is applied IS to the reference voltage line RL.

Voltages which are charged into the two liquid crystal capacitors Clca and Clcb are set to be slightly different from each other. For example, a data voltage which is applied to the liquid crystal capacitor Clca is set to be higher or lower than a data voltage which is applied to adjacent liquid crystal capacitor Clcb at all times. When the voltages of the two liquid crystal capacitors Clca and Clcb are appropriately adjusted as described above, an image which is seen from the side is closer to an image which is seen from the front, thereby improving a side visibility of the liquid crystal display.

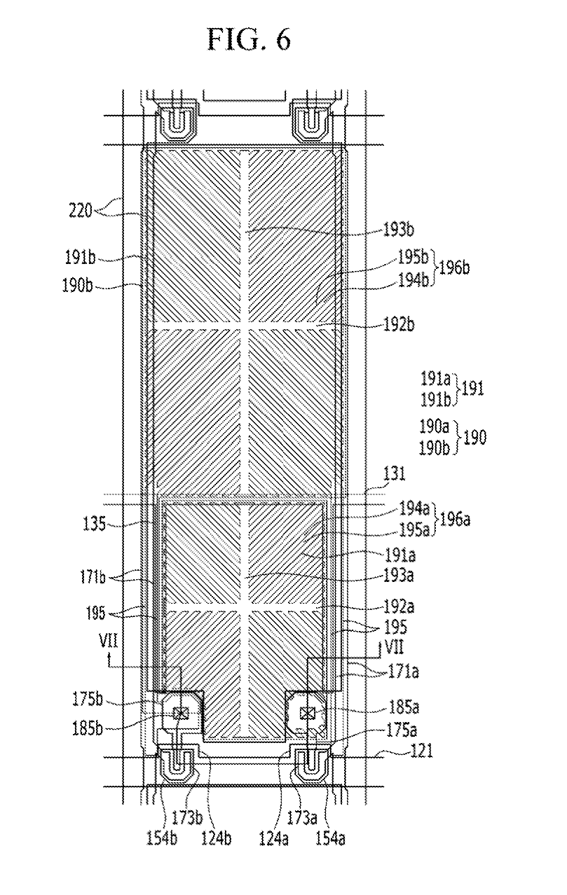

Now, a structure of the liquid crystal display device according to the exemplary embodiment illustrated in FIG. 5 will be described in brief with reference to FIGS. 6 to 8.

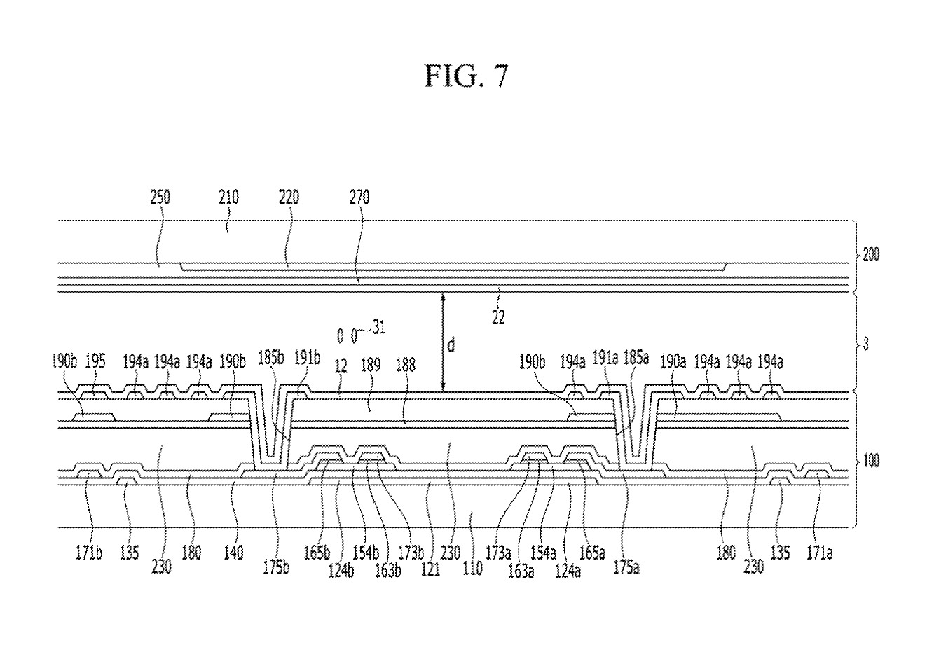

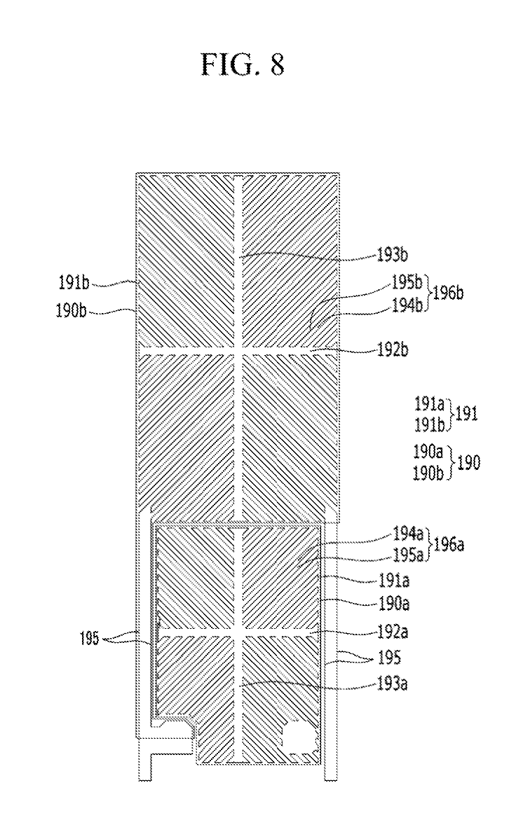

FIG. 6 is a layout view of one pixel of a liquid crystal display according to another exemplary embodiment of the present invention. FIG. 7 is a cross-sectional view of the liquid crystal display taken along the line VII-VII of FIG. 6. FIG. 8 is a top plan view illustrating pixel electrode of the liquid crystal display of FIG. 6.

Referring to FIG. 6 to FIG. 8, a liquid crystal display according to the present exemplary embodiment includes as first display panel 100 and a second display panel 200 which are opposite to each other and a liquid crystal layer 3 interposed between the first and second display panels 100 and 200.

Hereinafter, the first display panel 100 will be described.

A gate line 121 and a reference voltage line 131 are disposed on a first insulation substrate 110.

The gate line 121 transmits a gate signal and mainly extends in a horizontal direction. The gate line 121 includes as plurality of first and second gate electrodes 124a and 124b which upwardly protrudes.

The reference voltage line 131 extends to be substantially parallel to the gate line 121 and includes a storage electrode 135 which extends from the reference voltage line 131. Shapes and arrangements of the reference voltage line 131 and the storage electrode 135 may vary in various ways.

A gate insulating layer 140 is disposed on the gate line 121 and the reference voltage line 131 and a first semiconductor 154a and a second semiconductor 154b which are formed of an amorphous or polysilicon are disposed on the gate insulating layer 140. Further, the first semiconductor 154a and the second semiconductor 154b may be formed of oxide semiconductors.

A plurality of pairs of ohmic contacts 163a, 163b, 165a, and 165b are disposed on the first semiconductor 154a and the second semiconductor 154b, respectively. The ohmic contacts 163b and 165b may be formed of silicide or n+ hydrogenated amorphous silicon doped with an n-type impurity at a high concentration. Further, when the first semiconductor 154a and the second semiconductor 154b 154c are formed of the oxide semiconductors, the ohmic contacts 163b and 165b may be omitted.

Data conductors 171a, 17b, 173a, 173b, 175a, and 175b including a first data line 171a including a first source electrode 173a and a second data line 171b including a second source electrode 173b, a first drain electrode 175a, and a second drain electrode 175b are disposed on the ohmic contacts 163b and 165b and the gate insulating layer 140.

The first and second data lines 171a and 171b transmit data signals and mainly extend in a vertical direction to intersect the gate line 121 and the reference voltage line 131. The first source electrode 173a and the second drain electrode 175b overlap the first semiconductor 154a and the second source electrode 173b, and the second drain electrode 175b overlap the second semiconductor 154b. The first source electrode 173a and the first drain electrode 175a are opposite to each other with the first gate electrode 124a therebetween, and the second source electrode 173b and the second drain electrode 175b are opposite to each other with the second gate electrode 124b therebetween. However, the exemplary embodiment is not limited thereto, but shapes and arrangements of the first and second data lines 171a and 171b including the first and second drain electrodes 175a and 175b may vary in various ways.

Further, the first and second data lines 171a and 171b may include a wide end portion (not illustrated) to be connected with other layer or an external driving circuit.

The first gate electrode 124a, the first source electrode 173a, the first drain electrode 175a and the first semiconductor 154a form as first thin film transistor (TFT) Qa, and a channel of the first thin film transistor Qa is formed in the first semiconductor 154a between the first source electrode 173a and the first drain electrode 175a. Similarly, the second gate electrode 124b, the second source electrode 173b, the second drain electrode 175b and the second semiconductor 154b form a second thin film transistor Qb, and a channel of the second thin film transistor Qb is formed in the second semiconductor 154b between the second source electrode 173b and the second drain electrode 175b.

A passivation layer 180 is disposed on the data conductors 171a, 171b, 173a, 173b, 175a, and 175b and on exposed portions of the first and second semiconductors 154a and 154b. The passivation layer 180 may be formed of an inorganic insulating material such as silicon nitride or silicon oxide. The passivation layer 180 may prevent a pigment of a color filter 230, which will be described below, from inflowing into exposed portions of the first and second semiconductors 154a and 154b.

The color filter 230 is disposed on the passivation layer 180. The color filter 230 extends in a vertical direction along the first and second data lines 171a and 171b.

The color filter 230 may represent one of three primary colors of red, green, and blue. However, the color which is represented by the color filter is not limited to three primary colors of red, green, and blue but may be one of cyan magenta, yellow, and white.

An overcoat 188 is disposed on the color filter 230.

The overcoat 188 may be formed of an inorganic insulating material such as silicon nitride or silicon oxide. The overcoat 188 prevents the color filter 230 from being loosen and suppresses the contamination of the liquid crystal layer 3 by an organic material such as a solvent which inflows from the color filter 230, thereby preventing faulty such as an image lag caused when a screen is driven.

A lower pixel electrode 190 is disposed on the overcoat 188.

The lower pixel electrode 190 includes a first lower subpixel electrode 190a and a second lower subpixel electrode 190b which are separated from each other. The first lower subpixel electrode 190a and the second lower subpixel electrode 190b are located in a first subpixel area and a second subpixel area, respectively. The first subpixel area and the second subpixel area form one pixel area.

The first lower subpixel electrode 190a and the second lower subpixel electrode 190b have a planar shape having a whole plate shape over the first subpixel area and the second subpixel area.

The lower pixel electrode 190 may be formed of a transparent material such as ITO and IZO. Further, the lower pixel electrode 190 may be also formed of a reflective metal such as aluminum, silver, chromium or an alloy thereof.

An interlayer insulating layer 189 is disposed on the overcoat 188 and the lower pixel electrode 190. The interlayer insulating layer 189 may be formed of an organic insulating material such as silicon nitride or silicon oxide. Further, the interlayer insulating layer 189 may be formed of an organic insulating material.

A first contact hole 185a and a second contact hole 185b are located in the passivation layer 180, the color filter 230, the overcoat 188, and the interlayer insulating layer 189 to expose the first drain electrode 175a and the second drain electrode 175b, respectively.

An upper pixel electrode 191 is disposed on the interlayer insulating layer 189.

The upper pixel electrode 191 includes as first upper subpixel electrode 191a and a second upper subpixel electrode 191b which are separated from each other. The first upper subpixel electrode 191a overlaps the first lower subpixel electrode 190a and the second upper subpixel electrode 191b overlaps the second lower subpixel electrode 190b.

The upper pixel electrode 191 and the connecting member 197 may be formed of a transparent material such as ITO and IZO. The upper pixel electrode 191 and the connecting member 197 may be also formed of a reflective metal such as aluminum, silver, chromium or an alloy thereof.

The first upper subpixel electrode 191a and the second upper subpixel electrode 191b include cross-shaped stem portions which have a quadrangular shape as an overall shape and are formed of horizontal stem portions 192a and 192b, respectively and vertical stem portions 193a and 193b, respectively, intersecting the horizontal stem portions.

Further, the first upper subpixel electrode 191a and the second upper subpixel electrode 191b are divided into four sub regions by the horizontal stem portions 192a and 192b, respectively, and the vertical stem portions 193a and 193b, respectively, and each sub region includes a plurality of minute branch portions 196a and 196b, respectively. Each minute branch portion 196a and 196b includes minute branches 194a and 194b, respectively, and minute slits 195a and 195b, respectively.

The extension direction of each minute branch portion 196a forms approximately 40 degrees to 45 degrees with respect to the gate line 121 or with respect to the horizontal stem portions 192a. The extension direction of each minute branch portion 196b forms approximately 40 degrees to 45 degrees with respect to the gate line 121 or with respect to the horizontal stem portions 192b. Minute branch portions 196a and 196b of two adjacent sub regions may be perpendicular to each other.

The second upper subpixel electrode 191b includes a pair of branches 195 extending along the first and second data lines 171a and 171b. The branch 195 is located between the first upper subpixel electrode 191a and the first and second data lines 171a and 171b, and is connected to a lower end of the first upper subpixel electrode 191a.

The first upper subpixel electrode 191a and the first lower subpixel electrode 190a are physically and electrically connected to each other through the first contact hole 185a. Further, the first upper subpixel electrode 191a is physically and electrically connected to the first drain electrode 175a through the first contact hole 185a. Accordingly, a data voltage is applied to the first upper subpixel electrode 191a and the first lower subpixel electrode 190a from the first drain electrode 175a.

The second upper subpixel electrode 191b and the second lower subpixel electrode 190b are physically and electrically connected to each other through the second contact hole 185b. Further, the second upper subpixel electrode 191b is physically and electrically connected to the second drain electrode 175b through the second contact hole 185b. Accordingly, the data voltage is applied to the second upper subpixel electrode 191b and the second lower subpixel electrode 190b from the second drain electrode 175b.

Hereinafter, the second display panel 200 will be described.

A light blocking member 220 is formed on a second insulation substrate 210 which is formed of a transparent glass or plastic.

The light blocking member 220 extends along the data line 171 and the gate line 121. A width of the light blocking, member 220 may be larger than a width of the data line 171 and a width of the gate line 121. As described above, the width of the light blocking member 220 is larger than the width of the data line 171 and the width of the gate line 121 so that the light blocking member 220 may prevent the light which is incident from the outside from being reflected from a surface of the data line 171 which is formed of a metal. Accordingly, the light which is reflected from the surfaces of the data line 171 and the gate line 121 interferes with light which passes through the liquid crystal layer 3, which may prevent the contrast ratio of the liquid crystal display from being lowered.

A plantarization layer 250 is disposed on the light blocking member 220, a common electrode 270 is disposed on the plantarization layer 250, and an upper alignment layer 22 is disposed on the common electrode 270.

The lower alignment layer 12 and the upper alignment layer 22 may be formed of vertical alignment layers and may be formed of an alignment material such as polyamic acid, polysiloxane, or polyimide.

The liquid crystal layer 3 includes a plurality of liquid crystal molecule 31 having a negative dielectric anisotropy and the liquid crystal molecule 31 may be aligned such that a major axis is vertical to the surfaces of the first and second display panels 100 and 200 in a state where no electric field is applied.

Further, the liquid crystal layer 3 may include a prepolymer such as a monomer which is cured by polymerization by light. The prepolymer may include a reactive mesogen which is polymerized by light such as ultraviolet rays.

In the meantime, the lower alignment layer 12 and the upper alignment layer 22 may include prepolymer such as a monomer which is cured by polymerization by light. In this case, the liquid crystal layer 3 does not include the prepolymer.

The first upper subpixel electrode 191a and the first lower subpixel electrode 190a and the second upper subpixel electrode 191b and the second lower subpixel electrode 190b to which the data voltages are applied generate an electric field together with the common electrode 270 of the second display panel 200, to determine a direction of the liquid crystal molecules 31 of the liquid crystal layer 3 between the first display panel 100 and the second display panel 200. Luminance of the light which passes through the liquid crystal layer 3 varies depending on the direction of the liquid crystal molecules 31 determined as described above.

In the present exemplary embodiment, the plate shaped first lower subpixel electrode 190a and second lower subpixel electrode 190b are disposed to overlap the first upper subpixel electrode 191a and the second upper subpixel electrode 191b each including minute branches 194a and 194b, thereby increasing transmittance of the liquid crystal display.

More specifically, in regions corresponding to the minute slits 195a and 195b between the minute branches 194a and 194b of the first upper subpixel electrode 191a and the second upper subpixel electrode 191b, an electric field is generated between the whole plate shaped first lower subpixel electrode 190a and second lower subpixel electrode 190b and the common electrode 270 so that the electric field is prevented from being lowered even in a region where a cutout for forming a plurality of branch electrodes is formed, thereby increasing the transmittance of the liquid crystal display.

In the meantime, in the present exemplary embodiment, an interval S between the minute branches 194a of the first upper subpixel electrode 191a, and the interval S between the minute branches 194b of the second upper subpixel electrode 191b, that is a width S of the minute slits 195a and 195b (as shown in FIG. 4) is 2.7 to 5.0 times larger than as thickness d of the liquid crystal layer 3, that is, a cell gap d.

Now, a relationship of the width S of the minute slits 195a and 195b and the cell gap d will be described with reference to Table 2.

In Table 2, as compared with a structure of a pixel electrode including the first subpixel electrode and the second subpixel electrode having a minute branch portion including a plurality of minute slits and as plurality of minute branches, when a liquid crystal display according to the exemplary embodiment of the present invention, the lower pixel electrode including the whole plate shaped first lower subpixel electrode and second lower subpixel electrode interposes the upper pixel electrode including the first upper subpixel electrode and the second upper subpixel electrode having the minute branch portion with the insulating layer therebetween and the same voltage is applied to the lower pixel electrode and the upper pixel electrode, a ratio of the transmittance and a response time in a black state is measured, while changing a ratio of the width S of the minute slits 195a and 195b with respect to the cell gap d.

TABLE 2

| S/d | Transmittance (%) | Ton (%) |
|---|---|---|
| 1.3 | 85.5 | 10.1 |
| 1.7 | 49.9 | 3.3 |
| 2.0 | 52.7 | 82.9 |
| 2.7 | 102.2 | 1.8 |
| 3.3 | 102.7 | 1.9 |
| 4.0 | 102.6 | 2 |
| 5.0 | 103.0 | 2.2 |
| 5.3 | 92.3 | 1.9 |

Referring to Table 2, when a ratio of the width S of the minute slits 195a and 195b with respect to the cell gap d is 2.7 to 5.0, a ratio of the transmittance is 100% or higher than that of the structure of the pixel electrode which includes only minute branch portions. That is, it is understood that according to the liquid crystal display of the exemplary embodiment of the present invention, the transmittance of the liquid crystal display is increased.

It is also understood that when the ratio of the width S of the minute slits 195a and 195b with respect to the cell gap d is 2.7 to 5.0, a ratio of the response time in the black state is reduced by approximately 98% as compared with the structure of the pixel electrode which includes only minute branch portions. That is, it is understood that the response time in the black state of the liquid crystal display according to the exemplary embodiment of the present invention is much shorter. Therefore, it is understood that the luminance in the black state of the liquid crystal display according to the exemplary embodiment of the present invention is improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display device, comprising:
a first substrate;
a gate line and a first data line which are disposed on the first substrate and are insulated from each other;
a first thin film transistor which is connected to the gate line and the first data line;
a lower pixel electrode which is connected to the first thin film transistor;
an interlayer insulating layer which is disposed on the lower pixel electrode;
an upper pixel electrode which is disposed on the interlayer insulating layer and is connected to the first thin film transistor and the lower pixel electrode;
a second substrate which faces the first substrate;
a common electrode which is disposed on the second substrate; and
a liquid crystal layer which is disposed between the first substrate and the second substrate, wherein the lower pixel electrode and the upper pixel electrode overlap each other, the upper pixel electrode includes a plurality of minute branches, the lower pixel electrode has a whole plate shape in plan view, and a ratio of an interval between the minute branches with respect to a thickness of the liquid crystal layer is 2.7 to 5.0.

2. The liquid crystal display device of claim 1, wherein the liquid crystal layer includes liquid crystal molecules having a negative dielectric anisotropy.

3. The liquid crystal display device of claim 2, wherein the lower pixel electrode includes a first lower subpixel electrode and a second lower subpixel electrode which are separated from each other, and the upper pixel electrode includes a first upper subpixel electrode and a second upper subpixel electrode which are separated from each other.

4. The liquid crystal display device of claim 3, wherein the first lower subpixel electrode and the first upper subpixel electrode overlap each other, and the second lower subpixel electrode and the second upper subpixel electrode overlap each other.

5. The liquid crystal display device of claim 4, wherein each of the first upper subpixel electrode and the second upper subpixel electrode includes a cross-shaped stem portion which is formed of a horizontal stem portion and a vertical stem portion that intersects the horizontal stem portion, and the minute branches extend from the cross-shaped stem portion.

6. The liquid crystal display device of claim 5, further comprising:
a second thin film transistor which is connected to the gate line and the first data line; and
a third thin film transistor which is connected to an output terminal of the second thin film transistor.

7. The liquid crystal display device of claim 6, wherein the first lower subpixel electrode and the first upper subpixel electrode are connected to the first thin film transistor, and the second lower subpixel electrode and the second upper subpixel electrode are connected to the second thin film transistor.

8. The liquid crystal display device of claim 7, further comprising a reference voltage line which is connected to an output terminal of the third thin film transistor.

9. The liquid crystal display device of claim 5, further comprising:
a second data line which intersects the gate line; and
a second thin film transistor which is connected to the gate line and the second data line.

10. The liquid crystal display device of claim 9, wherein the first lower subpixel electrode and the first upper subpixel electrode are connected to the first thin film transistor and the second lower subpixel electrode and the second upper subpixel electrode are connected to the second thin film transistor.
